(19) United States
(12) Patent Application Publication
(10) Pub. No.: US 2009/0151628 A1
(43) Pub. Date: Jun. 18, 2009

(54) MODULAR PAINTING APPARATUS

(76) Inventors: Scott J. Clifford, Rochester Hills, MI (US); Eric D. Buchanan, Oxford, MI (US); James M. Kowalski, Lake Orion, MI (US); Roy A. Jerue, Bloomfield Hills, MI (US); Paul D. Copioli, Sterling Heights, MI (US); Michael G. Beem, Lake Orion, MI (US)

Correspondence Address: FRASER CLEMENS MARTIN & MILLER LLC, 28366 KENSINGTON LANE, PERRYSBURG, OH, 43551, US

(21) Appl. No.: 12/352,629

(22) Filed: Jan. 13, 2009

Related U.S. Application Data
(63) Continuation of application No. 10/691,763, filed on Oct. 23, 2003.
(60) Provisional application No. 60/420,612, filed on Oct. 23, 2002.
(60) Provisional application No. 60/420,971, filed on Oct. 24, 2002.
(60) Provisional application No. 60/423,636, filed on Nov. 4, 2002.

(51) Int. Cl. B05C 5/02

(52) U.S. Cl. 118/300

(57) ABSTRACT

An apparatus for processing objects includes an elevated tubular frame rail mounting a four axis robot arm with a tool such as a painting applicator. The robot is attached to a mounting base that moves along the rail permitting painting of the top and/or side of a vehicle body. Electrical power and fluid lines can be routed through the rail to the robot. Two such rails and multiple robots can be combined as a module for installation in a new or an existing painting booth.

### CROSS-REFERENCE TO RELATED APPLICATION

This application is a continuation of the co-pending U.S. patent application Ser. No. 10/691,763 filed Oct. 23, 2003.

This application claims the benefit of U.S. provisional patent application Ser. No. 60/420,612 filed Oct. 23, 2002, U.S. provisional patent application Ser. No. 60/420,971 filed Oct. 24, 2002, and U.S. provisional patent application Ser. No. 60/423,636 filed Nov. 4, 2002.

### FIELD OF THE INVENTION

The present invention relates generally to robotic painting systems and, in particular, to an apparatus, method, and system for painting external surfaces of vehicle bodies.

### BACKGROUND OF THE INVENTION

Prior art paint booths are well known. A typical prior art paint booth, used to paint the exterior surfaces of vehicle bodies in both continuous conveyance and stop station systems, includes an enclosure housing a plurality of paint applicators. In one configuration, the applicators are mounted on an inverted U-shaped support structure that includes two vertical supports, one on either side of the path of travel of the bodies, connected at their tops by a horizontal support. This support structure is used to paint the top surfaces of the body and the horizontal beam can be fixed or can have an additional degree of freedom to move along the top of the vehicle body being painted. Another painting device is used in the same painting zone to paint the sides of the body and generally does not have the capability to move laterally along the length of the body. Disadvantages of this type of painting apparatus include lack of flexibility to provide optimized standoff distance between the body surface and the applicator along with inefficient use of the allotted painting cycle time. In the case of the top surface painting machine, the paint applicators are mounted on a common beam: therefore, the distance between each paint applicator and the surface to be painted varies with the contours of the vehicle body. In the case of the side painting machine, the paint applicators do not move transverse to the path of the vehicle body. They can only paint the portion of the body that is in front of the applicator leaving a good portion of the available cycle time unused.

An alternative to the support structure has been floor-mounted robots disposed along the sides of the painting booth. The robots mount either spray guns or rotary applicators (bell machines) for directing atomized paint toward the vehicle body.

While rotary applicators have advantages over spray guns, there are some associated disadvantages. The prior art floor mounted robots, especially bell machines, are inherently very costly and limit visual access to the booth. The bell machines require more bells for the same throughput due to limited orientation capability. The additional bells use more paint per vehicle due to per bell paint waste during color changing. Prior art floor mounted robots also require significant booth modification when installed in existing paint booths, increasing installation time and cost, and require more booth length and width. The rail axis of floor mounted robots requires doors at both ends of the booth. The waist axis of the floor mounted robot requires an additional safety zone at the ends of the spray booth and the rail cabinets of the floor mounted robots encroach into the aisle space. Floor mounted robots also require frequent cleaning due to the down draft of paint overspray causing paint accumulation on the robot arm and base, which results in higher maintenance and cleaning costs.

The prior art bell zone machines also lack flexibility. Additional and more flexible robot zones are required because the prior art machines unable to reach substantially all paintable surfaces on one side of the body and, therefore, have limited backup capability for an inoperative painting machine. Additional robot zones are also used to provide backup capability for the less flexible prior art painting machine.

It is desirable, therefore, to provide a painting apparatus and a painting system that utilizes robots in an efficient and cost-effective manner that minimizes paint waste, occupies little space (length and width) in the paint booth and can be installed in existing paint booths without requiring significant booth modification. It is also desirable to provide a painting apparatus wherein one painting robot is able to reach substantially all paintable surfaces on one side of the article to provide backup capability in the case of an inoperative robot.

### SUMMARY OF THE INVENTION

The present invention concerns an apparatus, method, and system for painting objects in a paint booth or similar enclosure.

The present invention concerns a modular elevated rail adapted to be mounted in a paint booth for automated painting of conveyed articles such as automotive vehicle bodies. The modular elevated rail includes a frame enclosure having overhead-mounted rails straddling the line of conveyance of the articles. The conveyed articles may be moving or stationary during the painting process. The frame enclosure allows for higher rigidity and lower weight than is attained by conventional free standing, cantilevered rail mounts and occupies less space and realizes lower cost and less floor loading. At least one painting robot is mounted on a mounting location on the rail frame to move alongside, and at a higher elevation than, the articles such as to protect the rails from paint overspray and reduce the cost of covers for, maintenance of, and cleaning of the rails. The elevated rail frame in accordance with the present invention may be advantageously incorporated as part of a new paint booth assembly or installed as a retrofit device without requiring significant modification to the existing paint booth. The tubular arrangement of the modular elevated rail allows pre-wiring to be done at the production facility as opposed to an on-site wiring installation, providing numerous cost and quality-control benefits.

Preferably, a robot that provides four degrees of freedom is mounted on the frame rail, which provides another axis of freedom. The robot mounting location allows one painting robot to reach substantially all paintable surfaces on one side of the article in a degraded mode of operation. Preferably, opposed robots are provided for symmetric painting of the article. The robot primary axes (robot arms) advantageously operate in a vertically extending planar space. When an axi-symmetric paint applicator, such as a rotary bell, is mounted on the robot for painting, a sixth degree of freedom (orientation about the robot wrist faceplate) is not required as in the prior art. The sixth degree of freedom may be added if the application requires an asymmetric applicator.

The combination of the arm geometry of the robot and the mounting location of the elevated rail provides higher bell on time with minimal impact on booth size, allowing fewer robots to be installed in a small booth, and permitting use for painting in the space provided by existing booths.

### DESCRIPTION OF THE DRAWINGS

The above as well as other advantages of the present invention will become readily apparent to those skilled in the art from the following detailed description of a preferred embodiment when considered in the light of the accompanying drawings in which:

FIG. 1 is a perspective view of a modular elevated rail apparatus in accordance with the present invention;

FIG. 2 is fragmentary perspective view of an alternate embodiment of the elevated rail apparatus according to the present invention shown installed in a painting booth;

FIG. 3 is a fragmentary cross sectional view of a portion of the elevated rail apparatus of FIG. 1 installed in a painting booth in a first configuration;

FIG. 4 is a fragmentary cross sectional view similar to FIG. 3 showing the elevated rail apparatus installed in a painting booth in a second configuration;

FIG. 5 is a perspective view of one of the painting robots shown in FIG. 1; and

FIG. 6 is a front elevation view of the elevated rail apparatus of FIG. 1 installed in a painting booth for painting a vehicle body.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

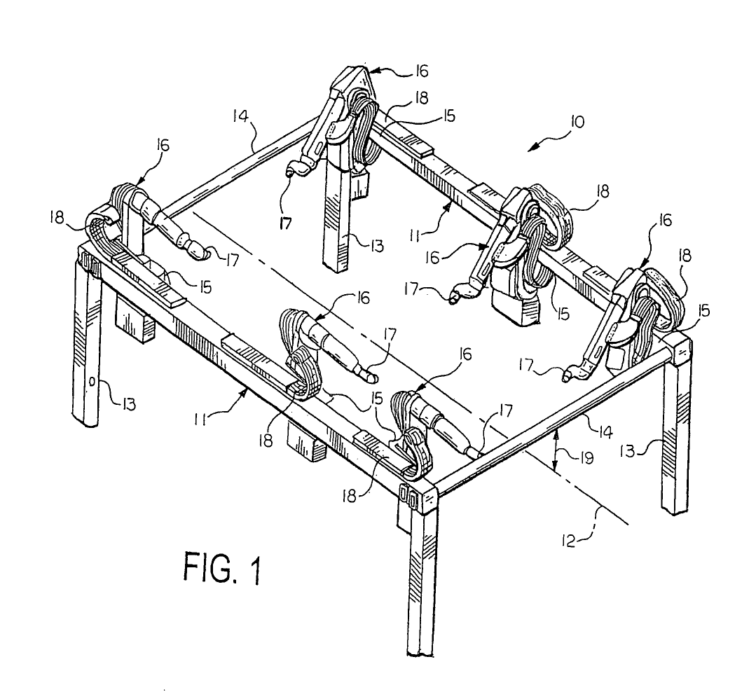

There is shown in FIG. 1 a modular elevated rail apparatus 10 for painting articles or objects in accordance with the present invention. The elevated rail apparatus 10 is adapted to be disposed in a paint booth as discussed below. The apparatus 10 includes a pair of frame rails 11 extending in a horizontal direction and spaced apart a predetermined distance on opposite sides of an axis 12 defining a path of travel for objects to be painted. Each end of each of the frame rails 11 is supported on an upper end of an associated one of a plurality of legs 13 adapted to engage a floor of the painting booth. Corresponding ends of the frame rails 11 can be connected by cross support members 14 that cooperate with the frame rails 11, the legs 13 and the booth floor to form a modular, supporting rigid box frame structure of the apparatus 10. If required for support, additional ones of the legs 13 and the members 14 can be attached intermediate the ends of the frame rails 11. The cross supports 14 may be substituted by a booth structure specifically designed to couple the two frame rails 11 in a rigid box frame structure.

The frame rails 11 each have at least one mounting base 15 attached thereto. Three such bases 15 are shown on each of the rails 11. Each of the mounting bases 15 is adapted to retain a painting device 16. The preferred painting device 16 is a robotic four axis articulated arm terminated at a free end by a paint applicator 17. The arm includes a shoulder axis, an elbow axis, a wrist rotating axis and a wrist tilting axis. Although a rotary bell atomizer is shown as the paint applicator 17, any known device such as a spray gun could be used. The painting device 16 and the mounting base 15 move together parallel to the longitudinal axis 12 to provide a fifth axis of movement. The painting device 16 is provided with electrical power and fluids, such as paint, compressed air and solvent, through a flexible ribbon 18 connected between the painting device and the frame rail 11. Preferably, the painting devices 16 are mounted in opposed pairs for simultaneously painting opposite surfaces of an object such an automobile body or the like (not shown) conveyed through the apparatus 10 along the axis 12. If the shown location of the axis 12 represents the top surfaces of the objects being painted, the frame rails 11, the support members 14 and the mounting bases 15 may be advantageously spaced a predetermined vertical distance 19 above the horizontal plane containing the axis 12.

The elevated rail apparatus 10 can easily be installed as a new painting booth is constructed, or as a retrofit to an existing paint booth without requiring significant modification to the existing paint booth. The frame rails 11, the legs 13 and the support members 14 can be brought into a painting booth and assembled into the rigid frame structure. Although the elevated rail apparatus 10 is described in terms of a painting process, the paint applicator 17 can be any tool suitable for performing a process on an object conveyed to the space between the two rails 11.

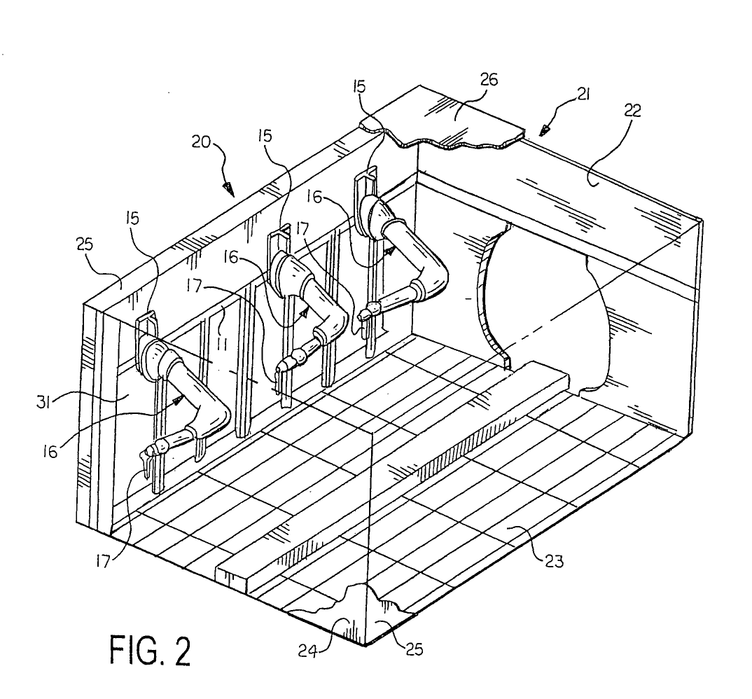

An alternate embodiment of the elevated rail apparatus according to the present invention is shown in FIG. 2 as an apparatus 20 installed in a painting booth 21. The painting booth 21 includes a rear or exit wall 22, a lower wall or floor 23, a front or entrance wall 24, a pair of side walls 25 and a top wall or roof 26. The right side wall 25, the front wall 24 and the top wall 26 are cut away to permit the interior of the booth 21 to be seen. The walls 22 through 26 are connected together to define an enclosed space in which the elevated rail apparatus 10 of FIG. 1 may be advantageously disposed. However, the alternate embodiment elevated rail apparatus 20 is adapted to be disposed in an upper portion of the paint booth 21 on the side walls 25. The apparatus 20 includes the frame rail 11 extending along an interior surface of the left side wall 25. The frame rail 11 can be attached to the side wall 25 by any suitable means. A second one of the frame rails 11 (not shown) is positioned on the opposite interior surface of the right side wall 25 such that the booth connects the frame rails 11 in a rigid frame structure. Movably attached to the frame rails 11 are the mounting bases 15 with the painting devices 16 and the painting applicators 17.

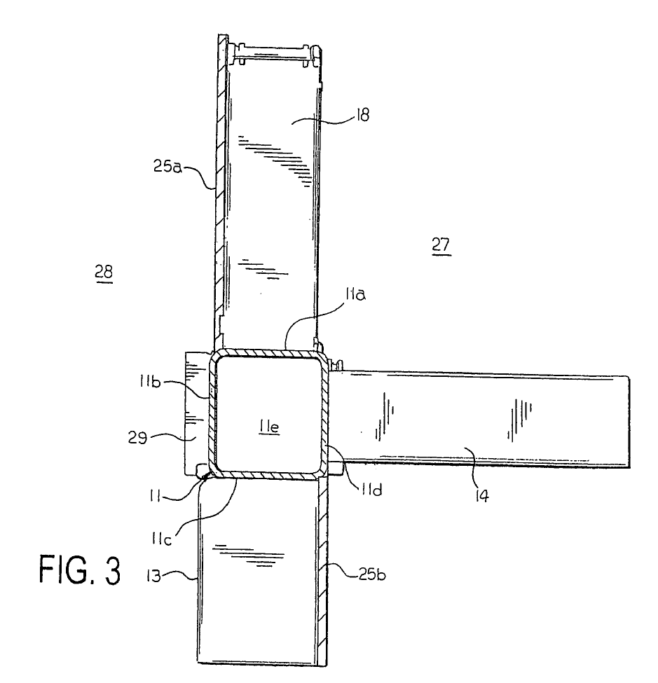

There is shown in FIG. 3 a portion of the apparatus 10 at a side wall of the painting booth. The side wall is split with an upper portion 25a above the frame rail 11 and a lower portion 25b below. The upper portion 25a abuts an upper surface 11a of the frame rail 11 near an outer side surface 11b. The lower portion 25b abuts a lower surface 11c of the frame rail 11 near an inner side surface 11b to which the cross support member 14 is attached. Thus, the frame rail 11 forms a part of the side wall separating an interior space 27 of the painting booth from an aisle 28 outside the booth. The frame rails 11 are made of tubular stock and are preferably rectangular in cross section having a hollow interior 11e. Alternatively, the frame rails 11 are formed from any shape of tubular stock including, but not limited to, circular stock. A coupling conduit 29 is attached to the surface 11b for routing electrical and fluid lines from the aisle 28 into the interior 11e of the frame rail 11. The cross support members 14 also are tubular for routing electrical and fluid lines. The frame rails 11 and the cross supports 14 can be sealed, purged and pressurized to function in the painting booth environment.

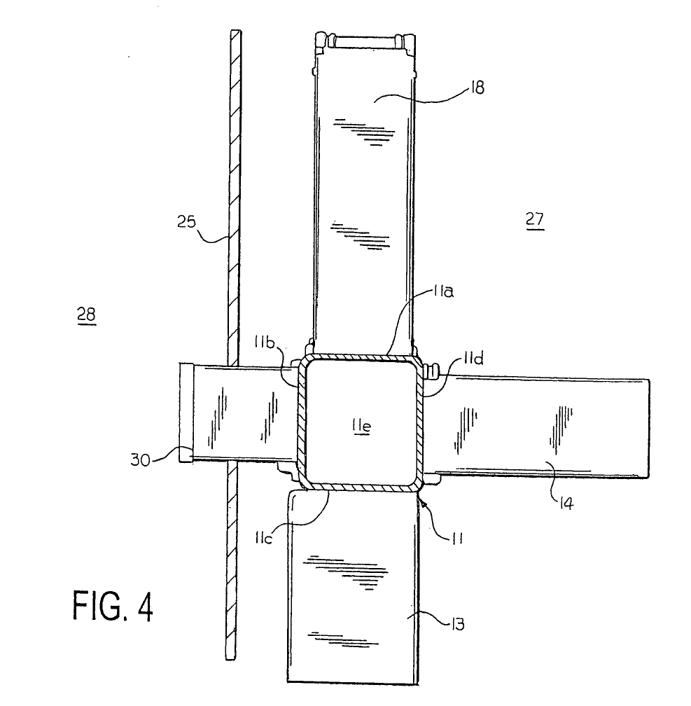

There is shown in FIG. 4 a portion of the apparatus 10 at the side wall 25 of the painting booth wherein the entire apparatus 10 is located in the interior 27 of the booth. A coupling conduit 30 is attached to the surface 11b for routing electrical and fluid lines into the interior 11e of the frame rail 11. The coupling conduit 30 extends through the side wall 25 into the aisle 28.

Elevating the frame rails 11 above the path of the upper surfaces of the objects being painted allows a simple means for connecting the cross support members 14 between the opposing frame rails providing a path for any supply lines. Thus, the electrical power and fluid sources can be located in the aisle 28 adjacent the exterior of the left side wall 25, for example, to supply the painting devices 16 on both sides of the booth. Also, it is advantageously less costly than adding support steel to the paint booth to support the cantilever loads of traditional prior art floor mounted robot rails.

In addition, elevating the frame rails 11 places many of the typical maintenance components such as linear axis drive components and cable and hose carriers (not shown) out of the area where the paint overspray would typically accumulate on equipment in a prior art down draft spray booth. These components do not need to be protected against the overspray as diligently as a prior art floor mounted rail. This advantageously lowers the cost for protective covers and seals (not shown) while lowering the ongoing maintenance cost over the life of the robots 16. Elevating the frame rails 11 also permits unobstructed viewing into the paint booth 21, through windows 31 (see FIG. 2) provided in the side wall 25, which is a benefit for system operators. The elevated rail apparatus 10 and 20 also allows access doors (not shown) to be placed in the side walls 25 when they would typically be located at the rear wall 22 and the front wall 24 of the booth 21. This again reduces the overall length of the booth 21.

Furthermore, elevating the frame rails 11 above the object, such as a vehicle body, to be painted allows the booth 21 to be made narrower than required for a traditional five to seven axis robot and does not require installation of components in the aisle 28 that are typically found in prior art floor-mounted installations. The elevated frame rail 11 and the robots 16 also advantageously allow the arm of each of the robots, discussed in more detail below, to reach under itself and paint the side of the vehicle because the robot base is not trapped between the side wall 25 and the vehicle.

As shown in FIGS. 1 and 2, a plurality of the articulated arm robots 16 is attached to the elevated frame rails 11 at various mounting bases 15 that move along the rails and allow the applicators 17 to follow an object to be painted, such as a vehicle body (not shown), as it moves through the paint booth 21. The applicators 17 are preferably a circular spray pattern bell applicator. By installing multiple articulated arm robots 16 on the common frame rails 11, the vehicle can be processed with each applicator 17 spraying for a higher percentage of time, and requiring fewer of the robots 16 and corresponding applicators 17 as compared to floor mounted systems.

With a simplified robot 16, the design of the structural elements of the elevated rail apparatus 10 and 20 (the frame rail 11, the legs 13 and the cross supports members 14) are fit within the narrow width space limitations of a standard bell zone paint booth 21. Furthermore, utilizing the elevated rail apparatus 10 in conjunction with the higher flexibility of a multi-axis manipulator, discussed in more detail below, yields higher application efficiencies, and thereby reduces the length overall length of a traditional bell zone paint booth 21.

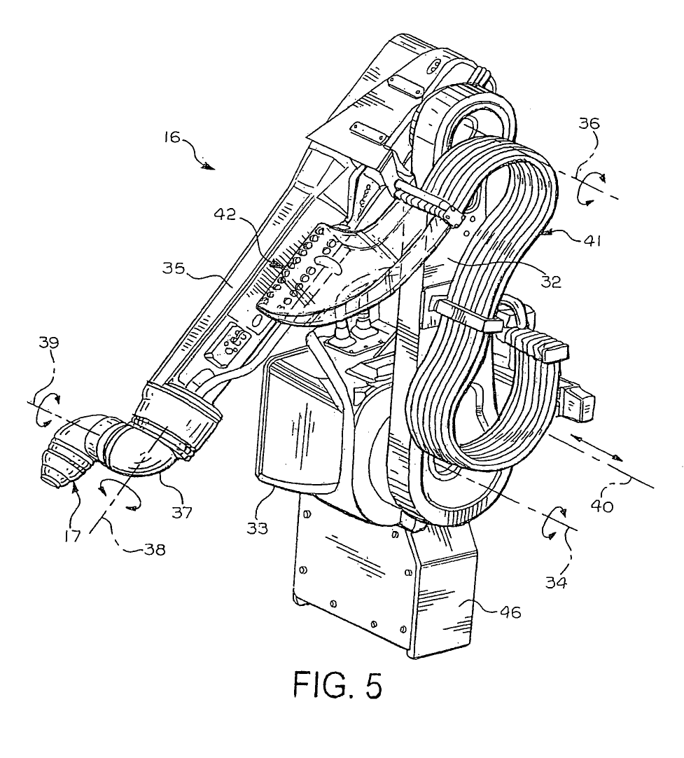

As shown in FIG. 5, the preferred painting device 16 is a four axis articulated arm robot terminated at a free end of the arm by the paint applicator 17 shown as a rotary bell applicator. The robot 16 includes a first or inner arm portion 32 mounted at a first end to a robot base 33 for rotation about a shoulder axis 34. A second or outer arm portion 35 is mounted at a first end to a second end of the inner arm 32 for rotation about an elbow axis 36. A wrist 37 attaches the paint applicator 17 to a second end of the outer arm 35 and has a rotating axis 38 and a tilting axis 39. The wrist 37 rotates the applicator 17 about the axis 38 which is generally parallel to a longitudinal axis of the outer arm 35 and rotates the applicator 17 about the axis 39 to tilt the applicator relative to the axis 38. Thus, the robot 16 provides four axes of motion relative to the base 33 for movement of the arm portions 32 and 35, the wrist 37 and the applicator 17 in vertical planes. A fifth axis of motion is a rail axis 40 provided through the attachment of the robot base 33 to the mounting base 15 (FIG. 1) for reciprocating movement of the robot 16 along the horizontal longitudinal axis of the associated frame rail 11 (FIG. 1).

Preferably, the structural components of the outer arm portion 35 and the wrist 37 are formed from a non-conductive material having suitable structural strength and impervious to the corrosive properties of solvents used in the painting environments, such as Lauramid A material. “Lauramid” is a registered trademark of Albert Handtmann ELTEKA Verwaltungs-GmbH of Biberach, Germany. The Lauramid A material is a castable polyamide Nylon 12G material that also provides for electrostatic isolation, cleanliness, cleaning capability, and weight advantages. Grounding of internal gearing (not shown) in the wrist 37 and other conductive components is not necessary for use in the paint booth 21 because they are suitably insulated. Non-grounded components are advantageously less likely to attract paint overspray resulting in a cleaner robot 16 requiring less maintenance and having better transfer efficiency of the paint to the vehicle, all resulting in less operating cost. The conductive components could also be charged at a lower or the same potential as the spray applicator.

A plurality of paint lines 41 is routed along the side of the inner arm 32 and connect to a color changer 42 mounted in the outer arm 35. The outer arm 35 houses a paint canister (not shown) for receiving a supply of paint through a selected one of the lines 41 and dispensing the paint to the applicator 17. Also housed within the outer arm 35 is a high voltage cascade (not shown) for electrostatically charging the paint for application to the object being painted.

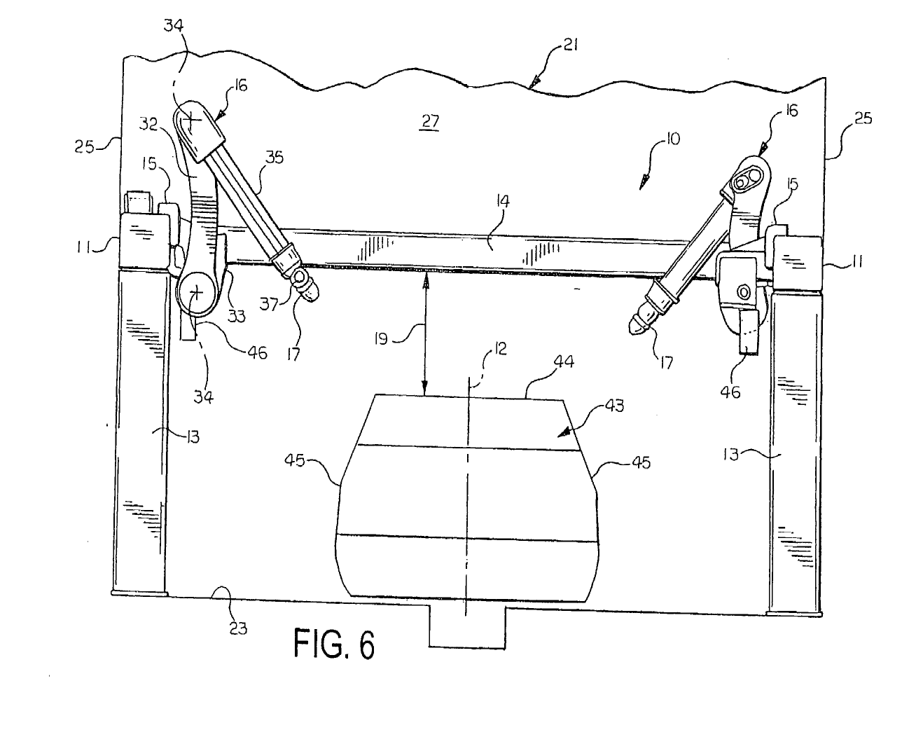

FIG. 6 shows the elevated rail apparatus 10 installed in the interior 27 of the painting booth 21 for painting a vehicle body 43. The base 33 and the shoulder axis 34 of each of the robots 16 are located above the horizontal plane of the axis 12 of movement of an upper surface 44 of the vehicle body 43 while the shoulder axis 34 is located below the frame rail 11 which maximizes the capability of the robots. A one of the robots 16 dedicated to painting the top 44 of the vehicle body 43 can advantageously paint a side 45 of the vehicle body if necessary in a degrade mode, such as if a one of the robots 16 dedicated to painting the side fails, because of the extension capabilities that the translation axes 34 and 36 provide. In addition, the elevated frame rails 11 and cross support members 14 allow for the placement of an enclosed process controller 46 (FIGS. 5 and 6), which includes pneumatic valves and bell control components (not shown), below the robot base 33 and in the paint booth 21, in an easily accessible type X purge enclosure.

The robot 16 being attached to the movable mounting base 15 on the elevated frame rail 11 allows the applicator 17 to follow the vehicle body 43 as it moves through the booth 21. By utilizing multiple opposed robots 16 on opposed frame rails 11, and by using a line tracking motion capability, the vehicle body 43 can be painted with each applicator 17 spraying for a high percentage of the available cycle time. For example, the robots 16 adjacent to the exit wall 22 (FIG. 2) can be spraying a portion of one vehicle body while the robots 16 adjacent to the entrance wall 24 can be spraying a portion of another vehicle body. Alternatively, if the vehicle body is conveyed to a stop within the space between the two rails 11, the robots 16 may still move along the rails to reach and paint all body surfaces desired to be painted.

The robot primary axes 34 and 36 advantageously operate the robot arm portions 32 and 35 in a vertically extending planar space orthogonal to the axis 12. Opposed robots 16 are provided for symmetric painting of objects such as the vehicle body 43.

Preferably control lines (not shown) are run through, or along, the cross support members 14 in order for a single controller (not shown) to control a pair of the opposed robots 16 for painting the opposite sides of the vehicle body 43.

The geometry of the robot 16 and the mounting base 15 allows one painting robot to reach substantially all paintable surfaces on the top 44 and one side 45 of the vehicle body 43 in a degraded mode of operation. The elevated rail apparatus 10 or 20 advantageously provides for the use of multiple robots 16 on the same frame rail 11 having the capability to paint various size vehicle bodies 43 within the paint booth 21. The geometry of the robot 16 and the elevated mounting location also eliminates human safety issues associated with placing traditional prior art robots in proximity of manual spray zones. Because the robot 16 is a planar device operating in a plane orthogonal to the longitudinal axis of the frame rail 11 and does not have a waist axis as in the prior art floor mounted painting robots and rail robot systems, the robot 16 does not extend the applicator 17 beyond the ends of the spray zone with an appreciable reduction in booth length. Furthermore, the geometry of the robot 16 and the elevated mounting location allows the robot to extend underneath the frame rail 11 into a protected enclosure (not shown) so that the robot can be serviced while the remaining robots 16 in the paint booth 21 continue painting. The protected enclosure has provisions for use of dynamic limiting devices to ensure operator safety.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A modular apparatus for performing a coating process on an object conveyed to and from a location comprising:
a pair of horizontal frame rails extending on opposite sides of a location of an object;
at least one robot arm mounted on an associated one of each of said frame rails, said robot arm movable along said associated frame rail in a linear manner, said at least one robot arm comprising at least one rotating arm linkage and not having a waist axis; and
a tool mounted on each of said at least one robot arms for performing a coating process on the object whereby said at least one robot arms move said tools relative to the object enabling said tools to perform the coating process on the object.

2. The apparatus according to claim 1 wherein said pair of frame rails further comprises at least two legs attached to each of said frame rails for elevating said frame rails above a plane of an upper surface of the object at the location.

3. The apparatus according to claim 2 wherein said pair of frame rails and said two legs further comprise at least one cross support member connecting said frame rails together to form a rigid frame structure with said legs.

4. The apparatus according to claim 1 wherein each said at least one robot arm extends to reach said tool mounted thereon to all exterior surfaces on a front, rear, top, and near side of the object.

5. The apparatus according to claim 1 wherein each said at least one robot arm includes a process controller mounted for movement therewith along said associated frame rail.

6. The apparatus according to claim 3 wherein said at least one cross support member is hollow for receiving cables and conduits.

7. The apparatus according to claim 4 wherein said at least one cross support member is tubular and purged with an inert gas or air for explosion protection.

8. The apparatus according to claim 1 wherein each said at least one robot arm includes two axes of motion defining a generally vertical planar operating space of said at least one robot arm.

9. The apparatus according to claim 1 wherein each said at least one robot arm includes a wrist connected between a free end of said at least one robot arm and said tool, said wrist having at least two axes of motion.

10. The apparatus according to claim 1 wherein each said at least one robot arm includes five axes of motion for orienting said tool relative to the object.

11. The apparatus according to claim 10 wherein the five axes of motion comprise a first horizontal linear axis formed by the rail, a second shoulder rotary axis, a third elbow rotary axis, and a wrist having a fourth and fifth axis.

12. The apparatus according to claim 1 wherein said frame rails are mounted on walls of a coating booth extending generally parallel to a path of movement of the object.

13. The apparatus according to claim 1 wherein said frame rails are mounted on floor engaging legs.

14. A modular apparatus for performing a coating process on an object conveyed to and from a location comprising:
a pair of horizontal frame rails extending on opposite sides of a location of an object, said frame rails being elevated above an upper surface of the object;
at least one robot arm mounted on an associated one of each of said frame rails, said robot arm movable along said associated frame rail in a linear manner said at least one robot arm not having a waist axis; and
a tool mounted on each of said at least one robot arms for performing a coating process on the object whereby said at least one robot arms move said tools relative to the object enabling said tools to perform the coating process on the object.

15. The apparatus according to claim 14 wherein said pair of frame rails further comprises two legs and at least one cross support member connecting said frame rails together to form a rigid frame structure with said legs.

16. The apparatus according to claim 14 wherein each said at least one robot arm extends to reach said tool mounted thereon to all exterior surfaces on a front, rear, top, and near side of the object.

17. The apparatus according to claim 14 wherein each said at least one robot arm includes a process controller mounted for movement therewith along said associated frame rail.

18. The apparatus according to claim 15 wherein said at least one cross support member is hollow for receiving cables and conduits.

19. The apparatus according to claim 15 wherein said at least one cross support member is tubular and purged with an inert gas or air for explosion protection.

20. The apparatus according to claim 14 wherein each said at least one robot arm includes two axes of motion defining a generally vertical planar operating space of said at least one robot arm.

21. The apparatus according to claim 14 wherein each said at least one robot arm includes a wrist connected between a free end of said at least one robot arm and said tool, said wrist having at least two axes of motion.

22. The apparatus according to claim 14 wherein each said at least one robot arm includes five axes of motion for orienting said tool relative to the object.

23. The apparatus according to claim 22 wherein the five axes of motion comprise a first horizontal linear axis formed by the rail, a second shoulder rotary axis, a third elbow rotary axis, and wrist having a fourth and fifth.

24. The apparatus according to claim 14 wherein said frame rails are mounted on walls of a coating booth extending generally parallel to a path of movement of the object.

25. The apparatus according to claim 14 wherein said frame rails are mounted on floor engaging legs.

26. A modular apparatus for performing a coating process on an object conveyed to and from a location comprising:
a pair of horizontal frame rails extending on opposite sides of a location of an object;
at least one robot arm mounted on an associated one of each of said frame rails, said robot arm movable along said associated frame rail in a linear manner said at least one robot arm having at least a first, second, and third major axes of movement wherein said first major axis is linear, said second major axis is a rotary axis extending in a horizontal plane, and said third major axis is a rotary axis extending in a horizontal plane; and
a tool mounted on each of said at least one robot arms for performing a coating process on the object whereby said at least one robot arms move said tools relative to the object enabling said tools to perform the coating process on the object.

27. The apparatus according to claim 26 wherein said pair of frame rails further comprises at least two legs attached to each of said frame rails for elevating said frame rails above a plane of an upper surface of the object at the location.

28. The apparatus according to claim 27 wherein said pair of frame rails and said two legs further comprise at least one cross support member connecting said frame rails together to form a rigid frame structure with said legs.

29. The apparatus according to claim 26 wherein each said at least one robot arm extends to reach said tool mounted thereon to all exterior surfaces on a front, rear, top, and near side of the object.

30. The apparatus according to claim 26 wherein each said at least one robot arm includes a process controller mounted for movement therewith along said associated frame rail.

31. The apparatus according to claim 28 wherein said at least one cross support member is hollow for receiving cables and conduits.

32. The apparatus according to claim 28 wherein said at least one cross support member is tubular and purged with an inert gas or air for explosion protection.

33. The apparatus according to claim 26 wherein each said at least one robot arm includes two axes of motion defining a generally vertical planar operating space of said at least one robot arm.

34. The apparatus according to claim 26 wherein each said at least one robot arm includes a wrist connected between a free end of said at least one robot arm and said tool, said wrist having at least two axes of motion.

35. The apparatus according to claim 26 wherein each said at least one robot arm includes five axes of motion for orienting said tool relative to the object.

36. The apparatus according to claim 35 wherein the five axes of motion comprise a first horizontal linear axis formed by the rail, a second shoulder rotary axis, a third elbow rotary axis, and a wrist having a fourth and fifth axis.

37. The apparatus according to claim 26 wherein said frame rails are mounted on walls of a coating booth extending generally parallel to a path of movement of the object.

38. The apparatus according to claim 26 wherein said frame rails are mounted on floor engaging legs.

39. A modular apparatus for performing a coating process on an object conveyed to and from a location comprising:
a pair of horizontal frame rails extending on opposite sides of a location of an object, said frame rails being elevated above an upper surface of the object;
at least one robot arm mounted on an associated one of each of said frame rails, said robot arm movable along said associated frame rail in a linear manner said at least one robot arm having at least a first, second and third major axes of movement wherein said first major axis is linear, said second major axis is a rotary axis extending in a horizontal plane, and said third major axis is a rotary axis extending in a horizontal plane; and
a tool mounted on each of said at least one robot arms for performing a coating process on the object whereby said at least one robot arms move said tools relative to the object enabling said tools to perform the coating process on the object.

40. The apparatus according to claim 39 wherein said pair of frame rails further comprises two legs and at least one cross support member connecting said frame rails together to form a rigid frame structure with said legs.

41. The apparatus according to claim 39 wherein each said at least one robot arm extends to reach said tool mounted thereon to all exterior surfaces on a front, rear, top, and near side of the object.

42. The apparatus according to claim 39 wherein each said at least one robot arm includes a process controller mounted for movement therewith along said associated frame rail.

43. The apparatus according to claim 40 wherein said at least one cross support member is hollow for receiving cables and conduits.

44. The apparatus according to claim 40 wherein said at least one cross support member is tubular and purged with an inert gas or air for explosion protection.

45. The apparatus according to claim 39 wherein each said at least one robot arm includes two axes of motion defining a generally vertical planar operating space of said at least one robot arm.

46. The apparatus according to claim 39 wherein each said at least one robot arm includes a wrist connected between a free end of said at least one robot arm and said tool, said wrist having at least two axes of motion.

47. The apparatus according to claim 39 wherein each said at least one robot arm includes five axes of motion for orienting said tool relative to the object.

48. The apparatus according to claim 47 wherein the five axes of motion comprise a first horizontal linear axis formed by the rail, a second shoulder rotary axis, a third elbow rotary axis, and a wrist having a fourth and fifth axis.

49. The apparatus according to claim 39 wherein said frame rails are mounted on walls of a coating booth extending generally parallel to a path of movement of the object.

50. The apparatus according to claim 39 wherein said frame rails are mounted on floor engaging legs.
